(19) United States
(12) Patent Application Publication
(10) Pub. No.: US 2018/0020864 A1
(43) Pub. Date: Jan. 25, 2018

(54) POPCORN MACHINES HAVING AUTOMATIC SIFTING SYSTEMS, AND ASSOCIATED METHODS OF OPERATION

(71) Applicant: C. Cretors & Company, Wood Dale, IL (US)

(72) Inventors: Andrew Cretors, Gurnee, IL (US); Charles D. Cretors, Lake Forest, IL (US); Nenad Vidojevic, Chesterton, IN (US)

(21) Appl. No.: 15/482,281

(22) Filed: Apr. 7, 2017

Related U.S. Application Data
(60) Provisional application No. 62/320,414, filed on Apr. 8, 2016.

(51) Int. Cl. A47J 27/00; A23L 7/178

(52) U.S. Cl. CPC A47J 27/002; A23L 7/178; A23V 2002/00

(57) ABSTRACT

Popcorn machines having automatic sifting systems, and associated methods of operation are disclosed herein. In one embodiment, a popcorn machine includes a cabinet for receiving popcorn and unpopped corn kernels. The popcorn machine also includes an automatic sifting system having a sifting component positioned at least partially within the cabinet to receive the popcorn and the unpopped corn kernels. The sifting component can include a plurality of perforations, and an agitator can be positioned to move the sifting component to agitate the popcorn and unpopped corn kernels. The agitation of the popcorn and the unpopped corn kernels moves the unpopped corn kernels toward and through the perforations.

### CROSS-REFERENCE TO RELATED APPLICATION(S)

The present application claims priority to of U.S. Patent Application No. 62/320,414, filed Apr. 8, 2016, and entitled “POPCORN MACHINES HAVING AUTOMATIC SIFTING SYSTEMS, AND ASSOCIATED METHODS OF OPERATION,” the entirety of which is incorporated by reference herein.

### TECHNICAL FIELD

The following disclosure relates generally to popcorn machines and, more particularly, to popcorn machines having automatic sifting systems and associated methods of operation.

### BACKGROUND

A variety of existing popcorn machines for use in theaters and other commercial settings include a kettle positioned within a cabinet. The kettle is generally hung from an upper wall in a case that occupies an upper portion of the cabinet. When popcorn is popped in the kettle, expansion of the popcorn fills the kettle and discharges the popped popcorn into the case. When a popping cycle is complete, the kettle is dumped into the case to empty any remaining popcorn into the case. In most popping cycles, at least some portion of the corn kernels do not pop or only partially pop. These unpopped and partially popped corn kernels (commonly referred to as “old maids”) are expelled from the kettle into the case with the popped popcorn. When an operator of the machine retrieves popcorn for a customer, it is likely that some unpopped and/or partially popped corn kernels will be included with the popcorn.

Some existing popcorn machines include perforations in a portion of a surface that receives the popcorn. The perforations can be sized to permit unpopped corn kernels to fall through, and an operator can manually agitate the popcorn to help move unpopped corn kernels through the perforations. However, manual agitation can damage the popped popcorn by breaking it into small pieces which are less appealing for consumption, and can be inefficient and only partially effective at removing unpopped corn kernels. Accordingly, even with manual agitation, unpopped corn kernels are often included in popcorn that is dispensed from such popcorn machines. In many instances, the inclusion of unpopped or partially popped corn kernels can result in dissatisfied customers and missed opportunities for repeat sales. In some instances, it can also result in minor injuries to customers (e.g., chipped teeth).

### BRIEF DESCRIPTION OF THE DRAWINGS

FIG. 1 is an isometric view of a popcorn machine having an automatic sifting system configured in accordance with an embodiment of the present technology.

FIG. 2 is a partially cutaway front view of a popcorn machine having an automatic sifting system configured in accordance with an embodiment of the present technology.

FIG. 3 is an isometric view of a portion of an automatic sifting system configured in accordance with an embodiment of the present technology.

FIG. 4 is a side view of an actuator for an automatic sifting system configured in accordance with an embodiment of the present technology.

FIG. 5 is an isometric view of a popcorn machine having an automatic sifting system configured in accordance with another embodiment of the present technology.

### DETAILED DESCRIPTION

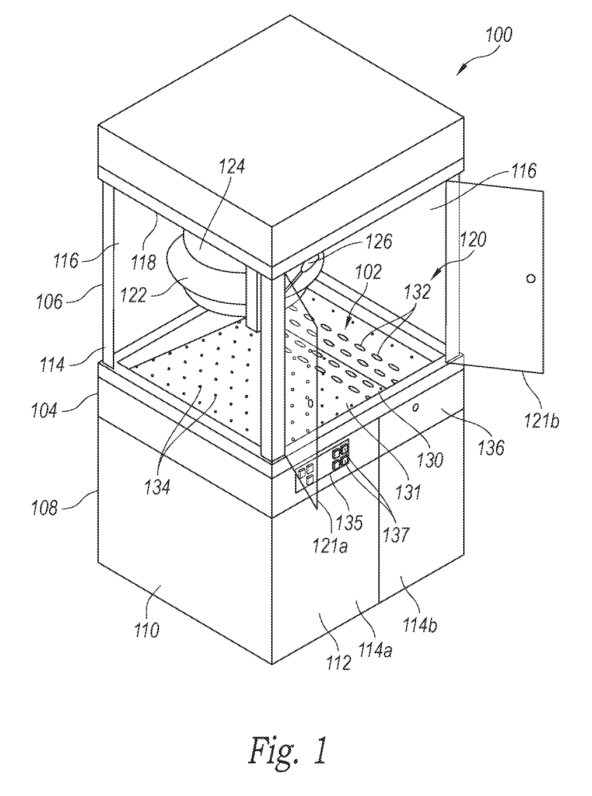

The following disclosure describes various embodiments of popcorn machines having automatic sifting systems for eliminating or at least reducing the presence of unpopped corn kernels, and associated systems and methods. In some embodiments, a popcorn machine includes an automatic sifting system having a movable sifting component with perforations. The perforations are sized to allow for passage of unpopped corn kernels through the perforations, while preventing popcorn from passing through the perforations. An agitator can be positioned to move the sifting component to agitate popcorn and unpopped popcorn positioned thereon. In several embodiments, an automatic sifting system can be positioned below a kettle within a cabinet of a popcorn machine that is sized and designed for use in commercial settings (e.g., theaters or concession stands). In other embodiments, the popcorn machines described herein can be used in industrial settings to popcorn for resale and the associated devices, systems and methods can have different configurations, components, and/or procedures. Still other embodiments may eliminate particular components and/or procedures. A person of ordinary skill in the relevant art, therefore, will understand that the present technology, which includes associated devices, systems, and procedures, may include other embodiments with additional elements or steps, and/or may include other embodiments without several of the features or steps shown and described below with reference to FIGS. 1-5.

As discussed above, many existing popcorn machines do not provide adequate removal of unpopped corn kernels. The present technology includes several embodiments of popcorn machines and associated systems and methods that have automatic sifting systems for removing all or most of the unpopped corn kernels from a mixture of popcorn and unpopped corn kernels. Certain details are set forth in the following description and FIGS. 1-5 to provide a thorough understanding of various embodiments of the disclosure. To avoid unnecessarily obscuring the description of the various embodiments of the disclosure, other details describing well-known structures and systems often associated with popcorn machines, sifting systems, agitators, and the components or devices associated with the manufacture of conventional popcorn machines or conventional sifting systems are not set forth below. Moreover, many of the details and features shown in the Figures are merely illustrative of particular embodiments of the disclosure. Accordingly, other embodiments can have other details and features without departing from the spirit and scope of the present disclosure. In addition, the various elements and features illustrated in the Figures may not be drawn to scale. Furthermore, various embodiments of the disclosure can include structures other than those illustrated in the Figures and are expressly not limited to the structures shown in the Figures.

FIG. 1 is an isometric view of a popcorn machine 100 having an automatic sifting system 102 configured in accordance with an embodiment of the present technology. In the illustrated embodiment, the popcorn machine 100 includes a housing 104 having an upper portion 106 and a lower portion 108. The lower portion 108 can include a base 110 with a front cover 112 and one or more doors 114a and 114b to provide access to an interior region of the lower portion 108. The upper portion 106 can include a display case or cabinet 114 having a plurality of see-through wall portions or panels 116 extending at least partially between the lower portion 108 and a top 118. The see-through panels 116 can be made of tempered glass, plexiglass, or other transparent material to allow viewing of the popping process and the popcorn stored in the cabinet 114. In the illustrated embodiment, the cabinet 114 includes an opening 120 to provide an operator (not shown) with access to an interior region of the upper portion 106. In various embodiments, the cabinet 114 can optionally include one or more doors 121a and 121b hingeably attached to the cabinet 114, to provide access to the opening 120. All or a portion of the doors 121 can be constructed from transparent materials like those of the see-through panels 116.

In another aspect of the illustrated embodiment, the popcorn machine 100 includes a popping kettle 122 positioned in an upper portion of the cabinet 114. The popping kettle 122 can be suspended from the top 118 of the cabinet 114, and can include a metal (e.g., a stainless steel) container that allows heat distribution to the un-popped corn kernels and cooking oil placed therein. The popping kettle 122 can include a heating element (e.g., an electrical heating element, gas heating element, etc.) for increasing the kettle temperature and popping the corn. The popping kettle 122 can also include a lid 124 that prevents popcorn and/or oil from escaping until the popping operation is nearly completed. The lid 124 can include a hinged portion that opens as the volume of popped corn increases within the kettle 122. In other embodiments, the lid can be configured to move upwardly to allow popcorn to discharge from the kettle 122. A handle or lever 126 is operably coupled to the popping kettle 122, and can be rotated downwardly to tip the popping kettle 122 over and dump the finished popcorn (not shown) into the cabinet 114 (i.e., into the interior region of the upper portion 106).

As described in more detail below, the automatic sifting system 102 includes a sifting component (e.g., a perforated deck 130) that can sift popcorn and unpopped corn kernels. The perforated deck 130 can include a surface 131 with a first plurality of perforations 132 to enable unpopped popcorn kernels to fall through the deck 130, and a second plurality of perforations 134 for flowing warm air upwardly into the cabinet 114 to warm and condition popcorn. The popcorn machine 100 can also include one or more control panels 135 having buttons or switches 137 for operating the kettle 122 and the automatic sifting system 102. Although the control panel 135 includes switches 137, it is to be understood that a variety of control panels, displays, touch panels, and other electrical, mechanical and/or electromechanical components and/or devices known in the art can be used to control operations of the popcorn machine 100, including the kettle 122 and the automatic sifting system 102. As used herein, the term “automatic sifting system” can include sifting systems having a variety of components and/or devices for controlling the associated sifting system. For example, in several embodiments, “simple” on/off switches can control one or more agitators and/or other components of a sifting system. In other embodiments, programmable logic controllers, computer based controllers (e.g., a computer readable medium storing executable instructions and a processor for executing the instructions), and/or other electronic and/or electromechanical controllers or systems can control the operation of one or more agitators or other components of a sifting system.

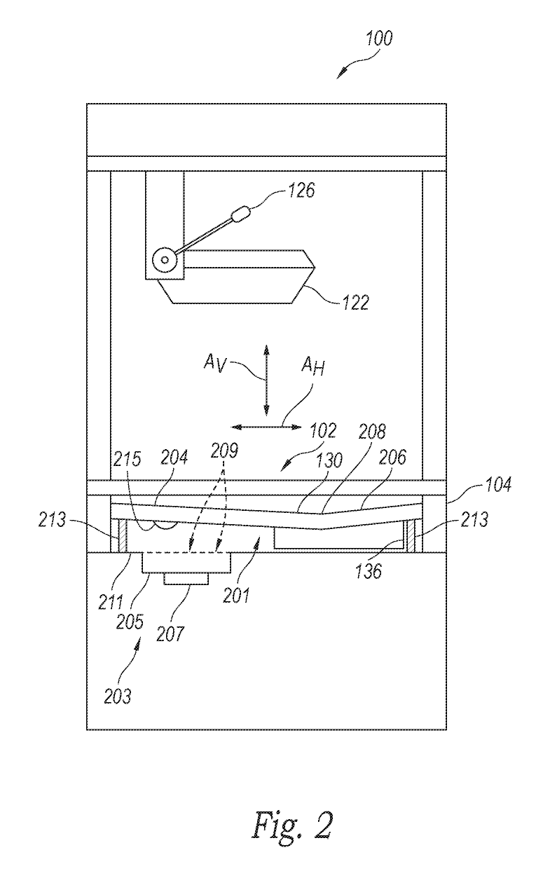

FIG. 2 is a partially cutaway front view of the popcorn machine 100 configured in accordance with an embodiment of the present technology. Referring to FIGS. 1 and 2 together, the popcorn machine 100 can also include a cleanout drawer 136 which is configured to slide into and out of a heated plenum 201 positioned under the perforated deck 130. A heating system 203 can be positioned below the plenum 201 and include an electric heating unit 205 in combination with a fan or other air mover 207 that directs heated air into the plenum 201 through vents or openings 209 in a divider 211. The heated air warms the contents of the plenum 201 and flows upwardly through the first perforations 132 and the second perforations 134 in the perforated deck 130 to warm popcorn in the cabinet 114.

In some embodiments, the popping kettle 122 and the cabinet 114 can be at least generally similar in structure and function to various models of popping kettles and cabinets manufactured and sold by C. Cretors & Company, of 176 Mittel Dr., Wood Dale, Ill. 60191. In other embodiments, the popcorn machine 100 can utilize other types of popping kettles, popping apparatuses, and/or cabinets known in the art. Other types of popcorn machines and popping apparatuses can include, for example, hot-air poppers, flow-through poppers, etc. Furthermore, in other embodiments the popping kettle 122 can be located in other positions relative to the cabinet. For example, in some embodiments the cabinet can be an open top cabinet, and the popping kettle can be positioned above, or at least partially above the open top. In other embodiments, the kettle 122 can be positioned closer to a sifting system (e.g., mounted to a lower portion of a cabinet or other structure in a popcorn machine). In still further embodiments, the automatic sifting systems and related structures and systems disclosed herein can be used with popcorn warmers that do not have popping kettles. Such warmers can include display cabinets that hold warmed popcorn produced from popping kettles remote from the cabinet. Accordingly, the present disclosure is not limited to the particular embodiments of the popping kettle 122, the cabinet 114, and/or the other features illustrated in FIGS. 1 and 2.

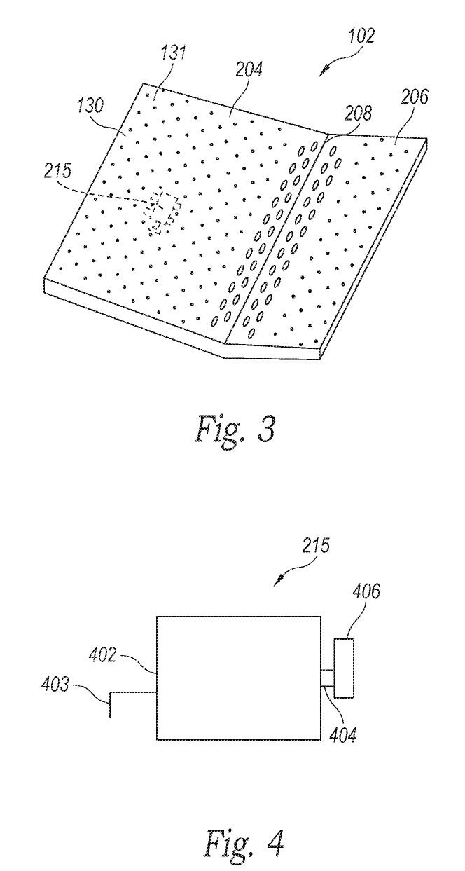

FIG. 3 is an isometric view of a portion of the automatic sifting assembly or system 102 configured in accordance with an embodiment of the present technology. Referring to FIGS. 2 and 3 together, the surface 131 of the perforated deck 130 includes a sloped first surface portion 204 and a sloped second surface portion 206. The first and second surface portions 204 and 206 both slope downwardly from opposite sides of the housing 104 toward a low point 208 near the first perforations 132 and define an obtuse angle therebetween. The sifting system 102 can include an actuator or agitator 215 operably coupled to an underside of the deck 202, and the deck 202 can be mounted to the divider 211 via a plurality of springs 213 (FIG. 2; e.g., four springs 213 positioned at corresponding corners of the deck 202). As described in more detail below, the agitator 215 can move the deck 202 and agitate popcorn and popcorn kernels in the cabinet 114 to drive unpopped and partially popped corn kernels toward the first perforations 132. As used herein, the term “unpopped corn kernels” can refer to unpopped corn kernels and/or partially popped corn kernels. In the illustrated embodiment of FIG. 3, the first perforations 132 can be larger than the second perforations 134 to provide for passage of unpopped corn kernels through the first perforations 132, and prevent passage through the second perforations 134. For example, the first perforations 132 can be elongated holes or slots having dimensions of approximately ⅜ of an inch by ¾ of an inch (6 mm by 19 mm), and the second perforations can be approximately ⅛ of an inch (3 mm).

FIG. 4 is a side view of the agitator 215 configured in accordance with an embodiment of the present technology. In the illustrated embodiment, the agitator 215 includes a motor 402 (e.g., an electric motor) having a power cord 403 and a rotatable shaft 404. An eccentric weight 406 is fixedly connected to an end portion of the shaft 404 to provide for motion of the deck 202. Specifically, with reference to FIGS. 1 through 4, operation of the automatic sifting system 102 can include rotation of the motor 402 to rotate the eccentric weight 406. As the eccentric weight 406 rotates, it exerts cyclic dynamic forces on the deck 202 by virtue of the motor 402 being mounted to an underside of the deck 202. The deck 202 is movably mounted to the divider 211 via the springs 213, and the dynamic forces transmitted to the deck 202 cause the deck 202 to react by moving. In particular, the forces produce both vertical and horizontal movement of the deck 202 having components in the directions shown by the arrows A_{V} and A_{H} (FIG. 2), respectively.

Movement of the deck 202 via the agitator 215 can move or agitate the popcorn and unpopped corn kernels in the cabinet 114, and differentially drive the unpopped corn kernels toward the low point 208 and the first perforations 132. Specifically, popped popcorn has a density of approximately 1.5 pounds per cubic foot, while unpopped popcorn has a density of approximately 45 pounds per cubic foot. The movement of the deck 202 agitates the popcorn and unpopped corn kernels causing the denser unpopped corn kernels to settle downwardly towards the deck 202 before the popped popcorn. The slopes on the first deck portion 204 and the second deck portion 206, combined with the motion of the unpopped corn kernels and the motion of the deck 202, progressively moves the unpopped corn towards the low point 208 and the first perforations 132. The unpopped corn kernels are larger than the second perforations 134, and cannot pass through deck 202 via the second perforations 134. However, the unpopped corn kernels are smaller than the first perforations 132, and movement of the unpopped corn kernels over the first perforations 132 causes the unpopped corn kernels to fall through the deck 202 and into the drawer 136. Continued movement of the deck 202 drives all or a majority of the unpopped corn kernels in the cabinet 114 through the deck 202 and into the drawer 136, leaving popcorn in the cabinet 114 that is free or relatively free of unpopped corn kernels.

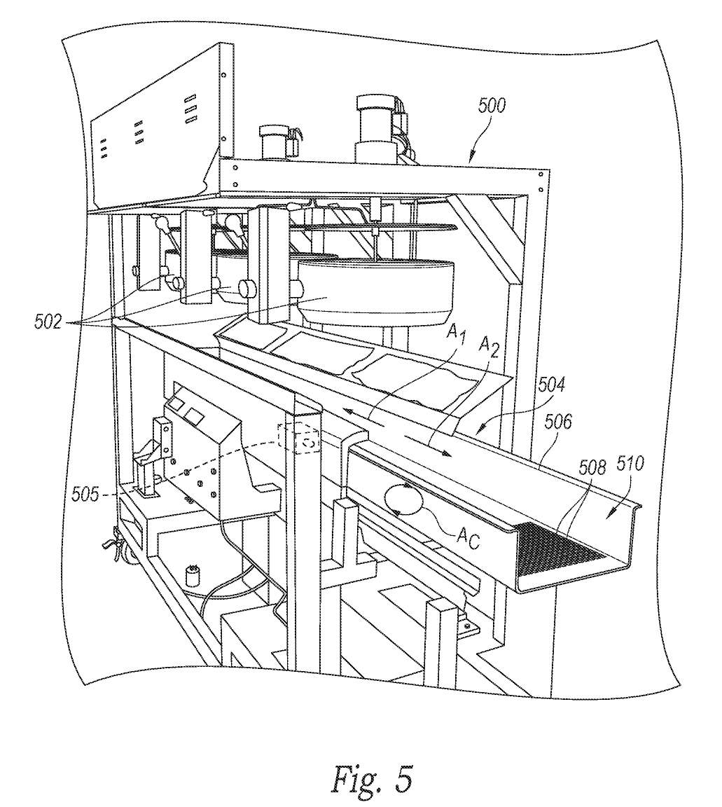

FIG. 5 is an isometric view of a popcorn machine 500 having an automatic sifting system 504 configured in accordance with another embodiment of the present technology. In the illustrated embodiment, the popcorn machine 500 includes a plurality of kettles 502, and the automatic sifting system 504 includes an agitator 505 and a sifting component (e.g., a flow-through trough 506). The kettles 502 are positioned to pop popcorn and discharge the popcorn onto the trough 506. The agitator 505 is positioned below the trough 506 and drives the trough 506 in a circular or oval pattern as indicated by arrow A_{C}. The motion of the trough 506 is not uniform, and includes quicker motion in a first direction shown by Arrow A₁ than a second direction shown by arrow A₂. The differential speed of the trough 506 drives popcorn and unpopped corn kernels in the direction of arrow A₂. Specifically, the relatively quick motion of the trough 506 in the first direction A₁ causes the trough 506 to move with respect to the popcorn and unpopped corn kernels positioned thereon. In contrast, the relatively slow motion of the trough in the second direction A₂ produces little or no relative motion between the popcorn and the trough 506. Accordingly, repeated cycles of the motion of the trough 506 drives the popcorn in the direction A₂.

The trough 506 includes a plurality of perforations 508 adjacent an end portion 510. Similar to the first perforations 132, the perforations 508 can be sized to allow for passage of unpopped corn kernels. As the popcorn and unpopped corn kernels advance to the perforations 508, the unpopped corn kernels fall through the perforations 508, and the popcorn continues along the trough 506. A receptacle (not shown) can be positioned adjacent the end portion 510 to collect the popcorn as it falls off the end of the trough 506.

In addition to the agitator 215, the automatic sifting systems 102 and 504 can include a variety of alternative and/or additional agitators to move the deck 202, the trough 506, and/or other sifting components. For example, in one embodiment one or more solenoids or other electromechanical devices can provide for motion of the deck 202 or the trough 506. In a particular embodiment, the deck 202 can be mounted on one or more electrically operated solenoids that can be activated to drive the deck 202. In another embodiment, the trough 506 can be mounted on one or more springs, and a pushrod can be connected between the trough 506 and a motor driven crankshaft via an eccentric bearing. The motor can drive the crankshaft at a constant speed, and the eccentric bearing can drive the pushrod back and forth at differential speeds to move the trough 506 in the manner described above. In other embodiments, one or more agitators can drive the deck 202 or the trough 506 in a variety of motions that provide for sifting of popcorn and unpopped corn kernels. For example, air or hydraulically driven devices or systems can drive the deck 202 or trough 506 in a variety of motions to sift popcorn and unpopped corn kernels. Importantly, regardless of the agitator or other device or system that provides for motion of the decks, troughs, and/or other sifting components, automatic sifting systems configured in accordance with the present technology can agitate popcorn and unpopped corn kernels to sift and remove the unpopped corn kernels.

In addition to the deck 202 shown in the embodiment of FIGS. 1-3 and the trough 506 shown in FIG. 5, a variety of alternative movable sifting components, decks, troughs, etc. can be included in automatic sifting systems configured in accordance with the present technology. In one embodiment, a deck can include three of more sloped portions that direct unpopped corn kernels toward a low point. For example, in a particular embodiment, a deck can include four sloped portions that slope toward a low point in a manner similar to a shower drain. In other embodiments, a deck can be sloped in a circular or oval shape that slopes toward a low point. In still other embodiments, a deck can include a generally flat surface that includes perforations sized for passage of unpopped corn kernels throughout a majority of the surface. For example, the deck 202 can be constructed such that the surface 131 is flat (i.e., without the sloped first and second portions 204 and 206) and include first perforations 132 throughout the majority of the surface 131.

In the embodiment illustrated in FIGS. 1-3, the cleanout drawer 136 is positioned beneath the first perforations 132 to catch and contain unpopped corn kernels. In several embodiments, the cleanout drawer 136 can extend beneath the entire surface 131 to catch unpopped corn kernels or other material that falls through the deck 202. For example, in embodiments having first perforations throughout a majority of the deck 202, the cleanout drawer 136 can extend beneath the entire surface 131 to catch unpopped corn kernels.

In one method for popping and sifting popcorn in accordance with the present technology, a popping operation produces popcorn and discharges popcorn and unpopped corn kernels onto a sifting system. An agitator moves a sifting component to agitate the popcorn and unpopped corn kernels and move the unpopped corn kernels toward perforations in the sifting component. The unpopped corn kernels are moved over the perforations and fall through the perforations, reducing the amount of unpopped corn kernels above or on the sifting component. Moving the unpopped corn kernels toward the perforations can include moving the unpopped corn kernels downwardly toward the sifting component, and laterally with respect to the sifting component. Additionally, moving the unpopped corn kernels downwardly can include moving or agitating the popcorn to enable the unpopped corn kernels to fall downwardly toward the sifting component via gravitational forces.

From the foregoing, it will be appreciated that specific embodiments have been described herein for purposes of illustration, but that various modifications may be made without deviating from the spirit and scope of the present technology. Those skilled in the art will recognize that numerous modifications or alterations can be made to the components or systems disclosed herein. Moreover, certain aspects of the present technology described in the context of particular embodiments may be combined or eliminated in other embodiments. Further, while advantages associated with certain embodiments have been described in the context of those embodiments, other embodiments may also exhibit such advantages, and not all embodiments need necessarily exhibit such advantages to fall within the scope of the present technology. Accordingly, the inventions are not limited except as by the appended claims.

1. A popcorn machine, comprising:
a cabinet;
a sifting component positioned at least partially within the cabinet to receive popcorn and unpopped corn kernels, wherein the sifting component includes a plurality of perforations; and
an agitator positioned to move the sifting component to agitate the popcorn and the unpopped corn kernels and move the unpopped corn kernels through the perforations.

2. The popcorn machine of claim 1 wherein the sifting component includes a first sloped surface portion and a second sloped surface portion, wherein the first and second sloped surface portions slope downwardly from opposite sides of the cabinet toward a low point, and wherein the perforations are positioned proximate to the low point.

3. The popcorn machine of claim 2 wherein the plurality of perforations are a first plurality of perforations, wherein the sifting component further comprises a second plurality of perforations, wherein the first plurality of perforations are shaped to enable the passage of unpopped corn kernels through the sifting component, wherein the second plurality of perforations are shaped to prevent the passage of unpopped corn kernels through the sifting component, and wherein the popcorn machine further comprises a blower positioned to direct heated air through the sifting component via the second plurality of perforations to heat popped popcorn within the cabinet.

4. The popcorn machine of claim 1 wherein the agitator comprises a motor and an eccentric weight.

5. The popcorn machine of claim 4 wherein the sifting component includes a deck having the plurality of perforations, and wherein the agitator is mounted to an underside of the deck.

6. The popcorn machine of claim 1, further comprising a drawer positioned at least partially within the cabinet and below the sifting component to receive unpopped corn kernels that pass through the perforations.

7. The popcorn machine of claim 1 wherein the cabinet includes an upper cabinet portion and a lower cabinet portion, and wherein the popcorn machine further comprises:
a divider positioned between the upper cabinet portion and the lower cabinet portion; and
a plurality of springs, wherein the sifting component is mounted to the divider via the plurality of springs.

8. The popcorn machine of claim 1, wherein the sifting component is mounted within the cabinet via a plurality of springs.

9. The popcorn machine of claim 8 wherein the agitator comprises a motor positioned to impart forces to the sifting component to move the sifting component and agitate the popcorn and the unpopped corn kernels to move the unpopped corn kernels through the perforations.

10. A popcorn machine, comprising:
a cabinet;
a kettle positioned within the cabinet and configured to pop corn kernels into popcorn and dump the popcorn within the cabinet; and
a sifting system positioned to receive the popcorn from the kettle and sift unpopped corn kernels from the popcorn.

11. The popcorn machine of claim 10 wherein the sifting system includes:
a deck having a plurality of perforations; and
a motor positioned to move the deck to drive the unpopped corn kernels through the perforations.

12. The popcorn machine of claim 11, further comprising a rotating mass coupled to the motor, wherein the motor is mounted to the deck, the deck is mounted within the cabinet via a plurality of springs, and the rotating mass imparts a motion to the deck.

13. The popcorn machine of claim 11, further comprising a removable sifting drawer positioned below the deck and positioned to receive the unpopped corn kernels.

14. The popcorn machine of claim 10 wherein the sifting system includes a deck having a sloped surface and a plurality of perforations, wherein the sloped surface slopes downwardly from a side of the cabinet toward the perforations.

15. The popcorn machine of claim 14 wherein the sifting system includes a motor positioned to impart forces to the deck to agitate the popcorn and unpopped corn kernels and drive the unpopped corn kernels through the perforations.

16. The popcorn machine of claim 10 wherein the sifting system includes a deck having a first plurality of perforations for sifting the unpopped corn kernels, and a second plurality of perforations, wherein individual first perforations are larger than individual second perforations, and wherein the popcorn machine further includes a blower positioned to blow heated air through the second plurality of perforations.

17. A system for popping popcorn and sifting popcorn kernels from popped corn, the system comprising:
a cabinet;
a kettle positioned within the cabinet for popping the popcorn;
a deck positioned within the cabinet to receive popped popcorn and unpopped corn kernels from the kettle, wherein the deck includes perforations for sifting the unpopped corn kernels; and
an agitator positioned to apply forces to the deck to move the deck and agitate the popcorn and unpopped corn kernels.

18. The system of claim 17, further comprising a plurality of springs, wherein the deck is mounted within the cabinet via the plurality of springs.

19. The system of claim 17 wherein the deck includes a plurality of sloped portions, wherein the plurality of sloped portions slope downwardly away from sides of the cabinet toward a low point.

20. The system of claim 19, further comprising a sifting drawer positioned below the low point to receive unpopped corn kernels, wherein the perforations are positioned above the sifting drawer.

21. The system of claim 17 wherein the agitator comprises a motor having an eccentric weight, and wherein the motor is operably coupled to the deck.
